(19) United States
(12) Patent Application Publication
(10) Pub. No.: US 2022/0230457 A1
(43) Pub. Date: Jul. 21, 2022

(54) METHODS AND APPARATUS FOR MAINTAINING PRIVACY OF LICENSE PLATE AND/OR OTHER INFORMATION

(71) Applicant: James Buscemi, Camarillo, CA (US)

(72) Inventor: James Buscemi, Camarillo, CA (US)

(21) Appl. No.: 17/578,433

(22) Filed: Jan. 18, 2022

Related U.S. Application Data
(60) Provisional application No. 63/138,787, filed on Jan. 18, 2021.

(51) Int. Cl. G06V 20/62; G06V 20/58

(52) U.S. Cl. CPC G06V 20/625; G06V 20/586

(57) ABSTRACT

Methods, apparatus, and a system for protecting privacy of license plate and/or other information are described. In some embodiments a controllable LCD filter is placed over a surface, such as the surface of a license plate, and used to selectively block the information which is visible through the controllable filter when the filter is not in an opaque state. In various embodiments the system includes a list of license plates whose owners have requested privacy and the system prevents the reporting or dissemination of information, including location information, reported to the system about the license plate. Users can register their license plate number, request privacy with collected plate information then being treated in accordance with the license plate owners wish. While license plate information can be protected other types of information can also be and sometimes are protected using the described techniques and/or apparatus.

### RELATED APPLICATIONS

The present application claims the benefit of U.S. Provisional Patent Application Ser. No. 63/138,787 which was filed on Jan. 18, 2021 and which is hereby expressly incorporated by reference in its entirety.

### FIELD

The present application relates to method and apparatus for maintaining the privacy of information such as license plate and/or other information.

### BACKGROUND

In modern society cameras are widespread. With the ever decreasing cost of cameras and the ease with which images can be communicated over the Internet or other networks, the use of cameras is likely to continue to increase.

While cameras can be useful for security and other applications, the ever increasing use of cameras creates privacy concerns. Cameras are being positioned not only to capture images on private premises, e.g., for security or other reasons, but also facing out into public thoroughfares in an attempt to capture images of cars and people passing by, e.g., in a public road. In addition vehicle mounted cameras are being used to capture images of neighborhoods, cars and other objects which are visible from public roads and/or in privately owned parking lots or garages where vehicles with cameras may travel and capture images as they travel.

Captured images, whether they are captured by stationary or moving cameras, are often tagged with time and geolocation information. Captured images can be, and often are, communicated in digital form either wirelessly or via wired communications link to one or more central image storage and/or processing facilities.

Images are often automatically processed to extract useful information which can be sold and/or correlated with other information. For example, licenses plates can be detected and the license plate numbers in images can be automatically extracted. In the case of a stationary camera facing a public road, this allows for the detection of vehicles passing along the road based on images of license plate numbers. The time and date a vehicle passes a particular point in the road can be stored and correlated with other information. Similarly license plate numbers can be captured by cameras at parking garages and/or by vehicle mounted cameras driven through shopping mall parking lots or other parking sites.

The collection of license plate number, date and location information using cameras provides useful information which can be used for a variety of purposes. Some examples include government purposes such as law enforcement purposes, but other purposes can include private business purposes, e.g., the collection of location information which can be used for tracking individuals and/or marketing to individuals.

While license plates are an example of one type of information that can be collected from camera images, other examples of information which can be visually captured include vehicle identification numbers (VINs), inspection sticker information and/or parking permit information. While such examples generally relate to vehicles, other devices may have plates, displays, labels meters, or permits mounted on them that display information which can be visually captured, e.g., by a camera. In many cases the displayed information is displayed so that an intended party or inspector can view, collect, or check the displayed information, but from a privacy perspective it would be desirable if the information was not easily visible at all times to other parties. In some cases, such as when a motor vehicle is on a public road, there may be legal requirements that particular information, e.g., license plate number information, be visible but such a legal requirement may not be applicable when the motor vehicle is on private property such as on the property of a private parking garage or the private property of the vehicle owner.

In view of the above, it should be appreciated that it would be desirable if methods and/or apparatus which could be developed that could be used to restrict access to visual information such as license plate numbers, permit information, identifier plates, etc. when such information does not have to be displayed or visible for legal or other reasons while still allowing the information to be displayed when the display of such information is legally required or desirable.

### SUMMARY

While the display of information has privacy implications, the methods and apparatus of the invention are directed to the technical problem of how to limit the display of information and/or control when information is displayed or hidden from view. The methods and apparatus can be used to control the visibility of vehicle license plate information but is also applicable to controlling public access to a wide variety of other types of information that might be publicly visible absent use of the methods and/or apparatus of the invention to limit the visibility of particular information.

In various exemplary embodiments, one or more controllable light filters are placed over surfaces which display information which is to be selectively blocked from view. In some embodiments the controllable light filter is implemented as an LCD panel which is transparent or semi-transparent during a first mode of operation and opaque during a second mode of operation. The transition between the modes of operation can be controlled electronically, e.g., by controlling a voltage supplied to the LCD panel that is used to control whether it is opaque or transparent/semi-transparent.

In various embodiment the controllable filter, e.g., light filter, is placed over a surface used to display information. The surface may be, and sometimes is, the surface of: i) a vehicle license plate; ii) a vehicle identification number (VIN) plate; iii) inspection sticker; iv) registration card or sticker, v) a usage meter (e.g., water or electric meter), vi) a permit, vii) building or construction related information form or viii) display device such as an LCD screen.

The controllable light filter is controlled in various embodiments automatically, based on user input and/or one or more sensed conditions. Multiple controllable filters can be, and sometimes are, placed at different locations on a vehicle or device with each of the filters potentially being controlled separately depending on what the filter covers. For example, a filter over a private parking lot sticker may be controlled to be visible when on the private property of a parking garage to which the sticker relates while a filter over the vehicle license plate number and/or an inspection sticker may be controlled to be opaque while on the private property of the parking garage.

In various embodiments sensor output(s), such as a GPS sensor output and/or a location sensor output, are provided to a filter control circuit or processor used to control filter operation.

In one exemplary embodiment a filter placed over the license plate of a vehicle is operated in a first transparent state when the GPS/location sensor indicates the vehicle is on a public road and operated in a second transparent state when the vehicle location is determined to be a location corresponding to private property. Vehicle movement can be, and sometimes is, also detected by a motion sensor and/or a car control system, and, in some such embodiments, vehicle motion information is taken into consideration when determining whether the filter over the vehicle license plate is to be operated in a transparent mode of operation or an opaque mode of operation. In some embodiments when the processor or control system detects or receives a signal indicating that the vehicle is moving, the filter over the license plate is operated in a transparent state whether or not the vehicle is on private property.

User input can be used to override default filter settings, e.g., with the user being able to specify that the license plate filter should be operated in the transparent or opaque state for particular locations whether or not the location corresponds to private property. For example, a user can configure the system to maintain the license plate filter in a transparent state while at his/her place of work even though the location may correspond to private property.

The processor in accordance with the invention can, and in some embodiments does, automatically control the license plate filter to operate in a transparent state when the device is at locations where license plates are legally required to be visible, e.g., when the vehicle is on a public road, but to be in an opaque state at other times, e.g., when on the owner's private property or some other piece of private property.

By automatically obscuring license plate and/or other information when legally allowed to do so, the risk of having one's license plate observed by moving vehicles driving along a road or parking lot is reduced. Similarly when a filter is used to obscure an inspection sticker or other identification information when legally allowed to do so the risk of images being taken of such information and used to invade one's privacy is reduced.

Over time law enforcement and/or the government may come to appreciate the importance of privacy of license plates and other information. It is hoped that individuals will, in time, be legally allowed to block the view of their license plates from individuals or cameras operated by entities other than law enforcement.

In the expectation that law enforcement may need to view license plates and/or other information blocked by one or more filters implemented in accordance with the invention, in some, but not necessarily all embodiments, law enforcement is provided the ability to wirelessly override the filter when operating in the mode in which viewing of information is blocked and to control the filter to switch to the transparent mode of operation.

An exemplary privacy protection method, in accordance with some embodiments, comprises: operating a first filter placed over a first surface displaying information to operate during a first period of time in transparent filter mode of operation; and operating the first filter to operate during a second period of time in opaque filter mode of operation. An exemplary privacy protection system, in accordance with some embodiments, comprises: a first filter positioned over a first surface displaying information; and a processor configured to control the first filter to: i) operate during a first period of time in transparent filter mode of operation; and ii) operate during a second period of time in opaque filter mode of operation.

An exemplary method for storing and using information associated with a vehicle license plate number, in accordance with some embodiments, comprises: storing in a storage device a list of license plate numbers and, for each license plate number corresponding information, said license plate numbers including a first license plate number, information corresponding to the first license plate number stored in said storage device including one or more of: i) billing information corresponding to the license plate holder; ii) address information corresponding to the license plate holder, and/or iii) privacy preference information indicating whether the license plate holder of the first license plate seeks to limit the distribution of information corresponding to the first license plate; monitoring for messages communicating a license plate number; and in response to receiving a first message communicating a license plate number, determining if the storage device includes information corresponding to the communicated license plate number.

Numerous additional features, benefits and embodiments are discussed in the detailed description which follows. Various features discussed in the summary are included in some embodiments but all the discussed features need not be included in each embodiment incorporating one or more of the discussed features.

### BRIEF DESCRIPTION OF THE FIGURES

FIG. 1 is a drawing of an exemplary system including controllable filters used to restrict access to viewing, cameras for capturing images, control devices used for controlling the controllable filters and a privacy and/or billing server coupled together.

FIG. 2A is a first part of an exemplary method of operating a device, including one or more controllable filters, to determine and control filter operation, in accordance with an exemplary embodiment.

FIG. 2B is a second part of an exemplary method of operating a device, including one or more controllable filters, to determine and control filter operation, in accordance with an exemplary embodiment.

FIG. 2C is a third part of an exemplary method of operating a device, including one or more controllable filters, to determine and control filter operation, in accordance with an exemplary embodiment.

FIG. 2D is a fourth part of an exemplary method of operating a device, including one or more controllable filters, to determine and control filter operation, in accordance with an exemplary embodiment.

FIG. 2 comprises the combination of FIG. 2A, FIG. 2B, FIG. 2C and FIG. 2D.

FIG. 3 is a drawing of an exemplary vehicle including a plurality of controllable filters in accordance with an exemplary embodiment.

FIG. 4 is a drawing illustrating a police vehicle sending a wireless filter control signal to a vehicle including a controllable filter, said control signal overriding the current setting of the controllable filter and causing the controllable filter to operate in transparent filter mode.

FIG. 5 is a drawing illustrating a mobile wireless device sending a wireless filter control signal to control a home site controllable filter to operate in transparent filter mode.

FIG. 6 is a drawing illustrating a plurality of parking garages, including cameras and license plate readers, coupled to a privacy and/or billing server, which processes received information corresponding to captured license plates and uses and/or distributes the information in accordance with stored privacy settings in accordance with an exemplary embodiment.

FIG. 7 is a flowchart of an exemplary method of storing and using information associated with a vehicle license plate number in accordance with an exemplary embodiment.

### DETAILED DESCRIPTION

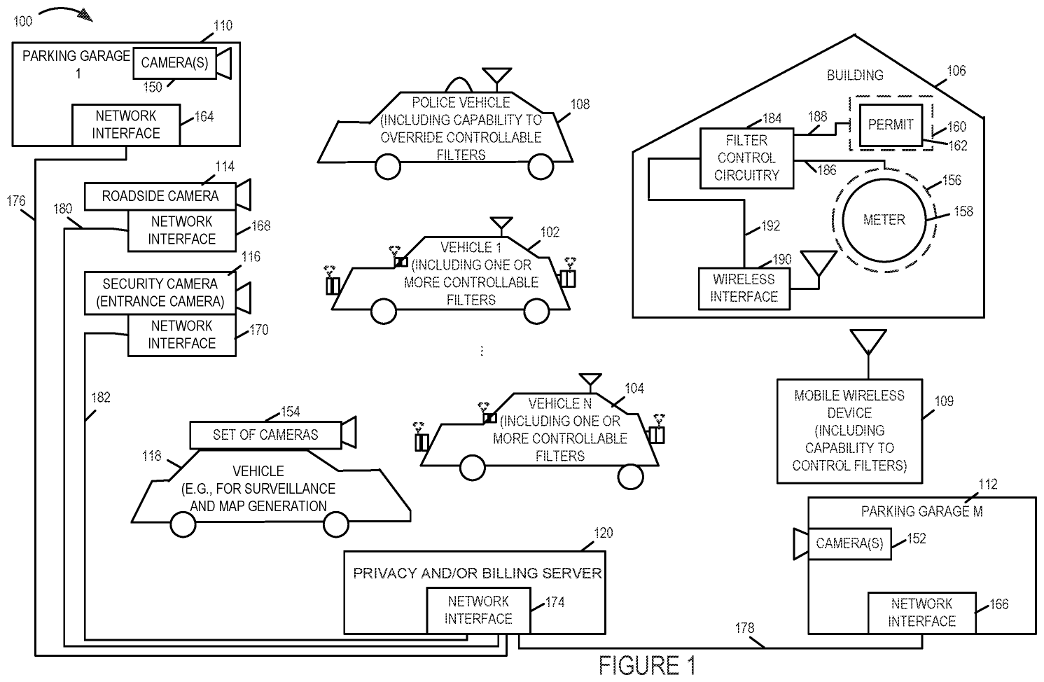

FIG. 1 is a drawing of an exemplary system 100 including controllable filters (e.g., included as part of vehicles or at fixed sites, e.g., homes) used to restrict access to viewing, cameras for capturing images, control devices used for controlling the controllable filters, and a privacy and/or billing server coupled together. Exemplary communications system 100 includes a plurality of vehicles (vehicle 1 102, . . . , vehicle N 104), each including one or more controllable filters, e.g. license plate viewing filters, tag or decal viewing filters, window viewing filters, etc., a police vehicle 108 including the capability to override controllable filters of vehicles 102, 104, a plurality of parking garages (parking garage 1110, . . . , parking garage M 112) each including one of more cameras (150, . . . , 152), respectively, used to collect images including license plate images and report captured images, information extracted from captured images, e.g., license plate numbers, and related information, e.g. time tag information, e.g., to a privacy and billing server 120. Exemplary system 100 further includes a roadside camera 114 used to collect images including license plate image of vehicles, a security camera 116, e.g., an entrance camera, used to collect images including license plate images, a vehicle 118, e.g., a surveillance vehicle or map generation vehicle, including a set of cameras 154, which captures images of both public and private property.

Exemplary system 100 further includes a building 106 including a first controllable filter 156 (typically set to opaque filter mode) covering the face of meter 158, and a second controllable filter 160 (typically set to opaque filter mode) covering a permit 162, e.g. a building or construction permit, or other information, e.g. an interior map of the building, fire safety information, evacuation information, etc., a mobile wireless device 109, e.g., of a meter reader or inspector or official or emergency personnel, said device 109 including the capability to set a controllable filter to a transparent filter mode of operation and allow the person to view the covered information.

The parking garage 1 110 includes network interface 164 coupled to camera(s) 110. Parking garage M 112 includes network interface 166 coupled to camera(s) 152. Roadside camera 114 is coupled to network interface 168. Security camera 116 is coupled to network interface 170. The various network interfaces (164, 166, 168, 170) are coupled to network interface 174 of privacy and/or billing server 120 via communications links (176, 178, 180, 182), respectively. Building 106 includes filter control circuitry 184 coupled to filters (156, 160) via communications links (186, 188), respectively. Building 106 further includes wireless interface 190, which is coupled to the filter control circuitry 184, via communications link 192. Mobile wireless device 109 may, and sometimes does, communicates with wireless interface 190 to control the filters (156, 160) within building 106.

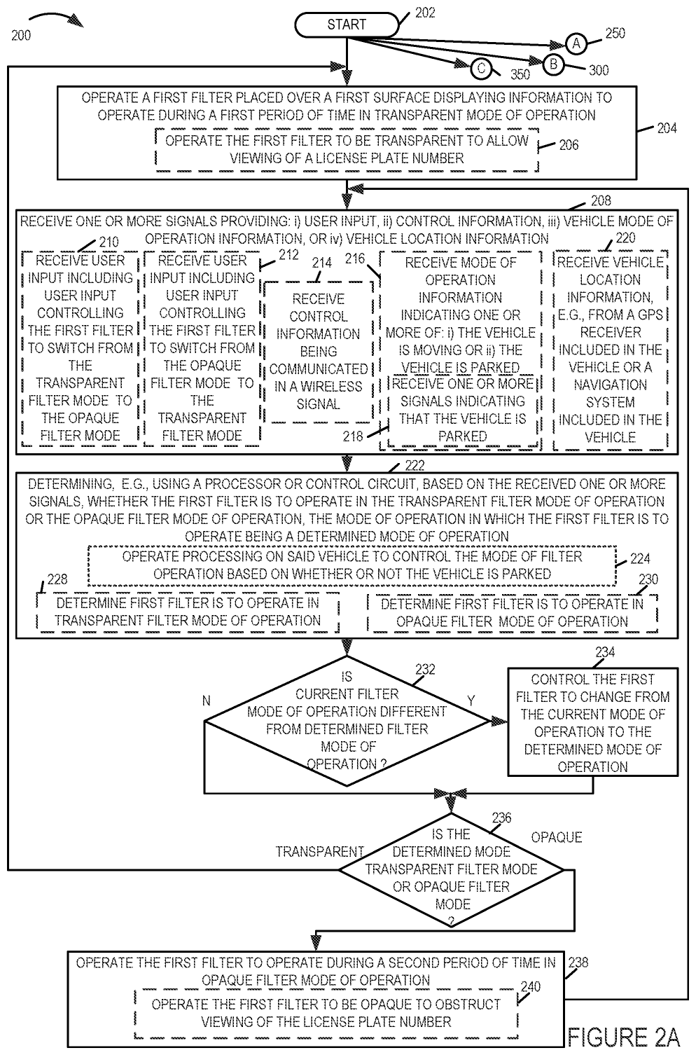

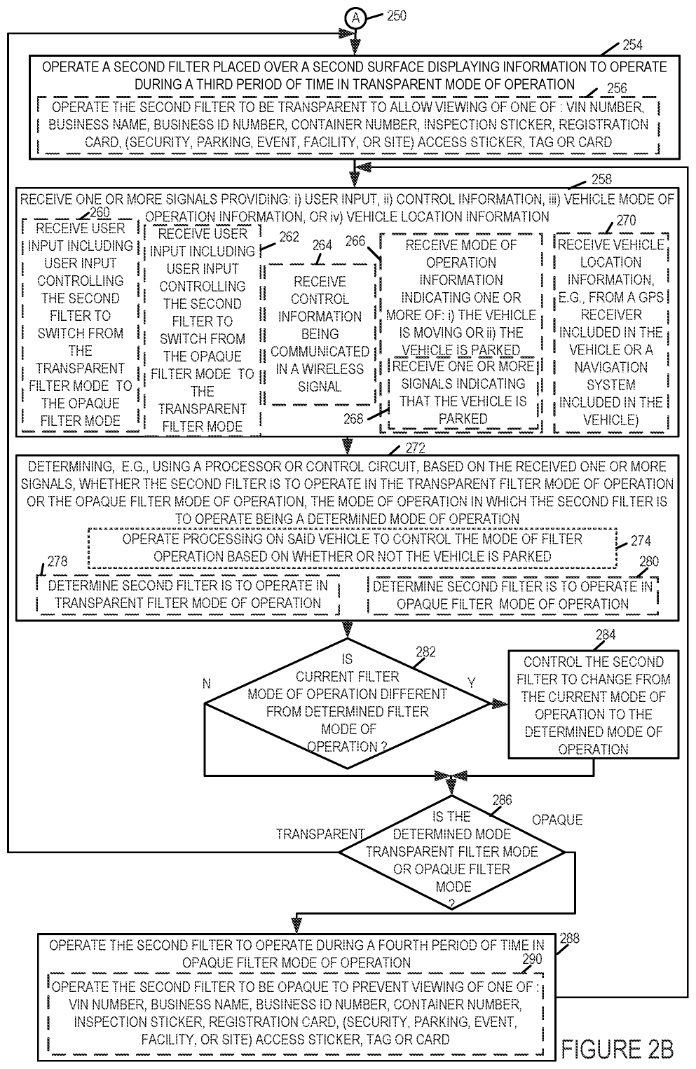

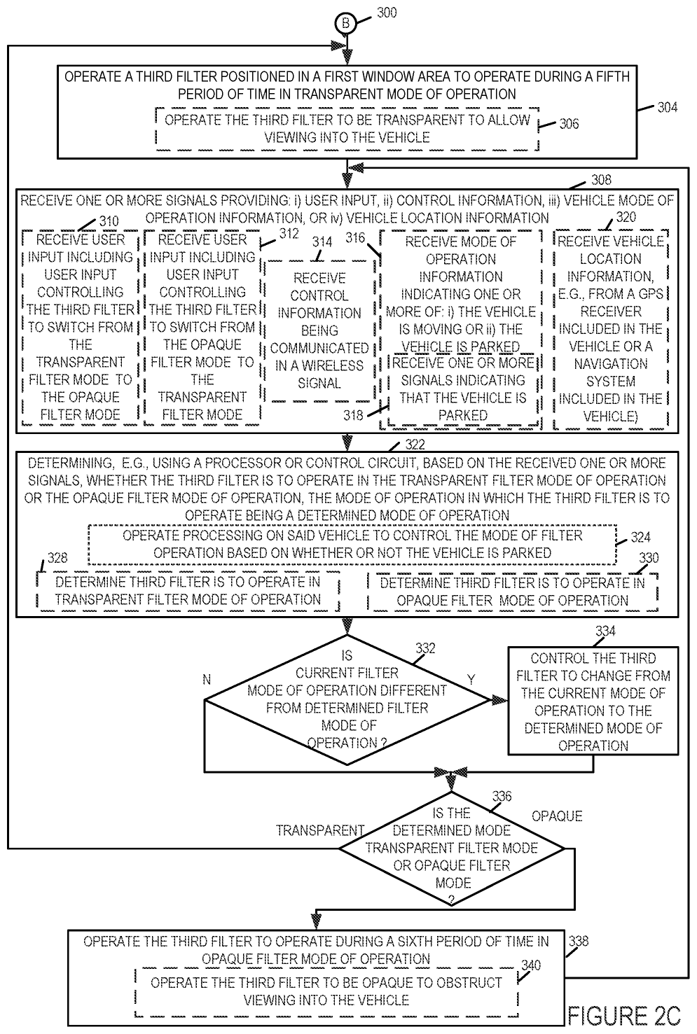

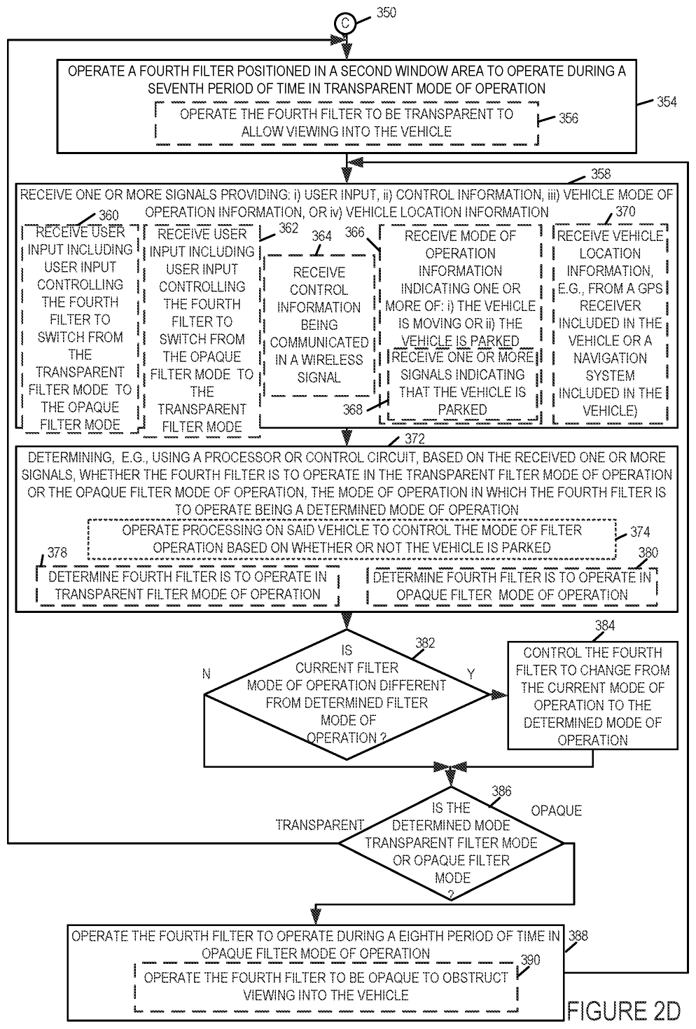

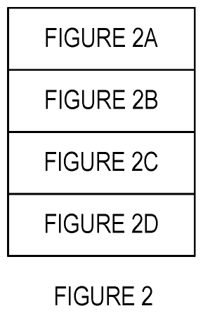

FIG. 2, comprising the combination of FIG. 2A, FIG. 2B, FIG. 2C and FIG. 2D, is a flowchart 200 of an exemplary method of operating a device, e.g., a vehicle including one or more controllable filters, to determine and control filter operation, in accordance with an exemplary embodiment. In some embodiments, the device is a set of components, e.g., a set of components mounted on a vehicle, e.g., the set of components includes a controllable filter, a wireless interface including a wireless receiver and optionally a wireless transmitter, an antenna, a processor, and memory coupled together.

Operation starts in step 202 in which the device is powered on and initialized. Operation proceeds from start step 202 to step 204. In some embodiments, e.g., embodiments including a plurality of controllable filters, operation also proceeds from step 202 to one or more of all of: step 252, via connecting node A 250, step 304 via connecting node B 300, and step 354 via connecting node C 350.

In step 204 the device operates a first filter placed over a first surface displaying information to operate during a first period of time in transparent mode of operation. In some embodiments, the first surface is the surface of a license plate, and step 204 includes step 206, in which the device operates the first filter to be transparent to allow viewing of the license plate number. Operation proceeds from step 204 to step 208.

In step 208 the device receives one or more signals providing: i) user input, ii) control information, iii) vehicle mode of operation information, or iv) vehicle location information. Step 208 includes one or more of steps 210, 212, 214, 216 and 220. During different iterations of step 208 different ones of steps 210, 212, 214, 216, and 220 may be performed. In step 210 the device receives user input including user input controlling the first filter to switch from the transparent filter mode to the opaque filter mode. In step 212 the device receives user input including user input controlling the first filter to switch from the opaque filter mode to the transparent filter mode. In step 214 the device receives control information being communicated in a wireless signal. In step 216 the device receives mode of operation information indicating one or more of: i) the vehicle is moving or ii) the vehicle is parked. In some embodiments, step 216 includes step 218 in which the device receives one or more signals indicating that the vehicle is parked. In step 220 the device receives location information, e.g., from a GPS receiver included in the vehicle or from a navigation system included in the vehicle. Operation proceeds from step 208 to step 222.

In step 222 the device determines, e.g., using a processor or control circuit, based on the received one or more signals, whether the first filter is to operate in the transparent mode of operation or the opaque mode of operation, the mode of operation in which the first filter is to operate being a determined mode of operation. Step 222 may, and sometimes does, include step 224, in which the device operates a processor on the vehicle to control the mode of filter operation based on whether or not the vehicle is parked. Each iteration of step 222 includes one of steps 228 and 230. In step 228 the device determines that the first filter is to operate in transparent filter mode of operation. In step 230 the device determines that the first filter is to operate in opaque filter mode of operation. Operation proceeds from step 222 to step 232.

In step 232 it is determined if the current filter mode of operation is different from the determined filter mode of operation. If the current filter mode of operation is different than the determined filter mode of operation, then operation proceeds from step 232 to step 234; otherwise, operation proceeds from step 232 to step 236.

In step 234, the device controls the first filter to change from the current mode of operation to the determined mode of operation. Operation proceeds from step 234 to step 236.

In step 236, if the determined mode of operation is transparent filter mode, then operation proceeds from step 236 to the input of step 204. However, in step 236, if the determined mode of operation is opaque filter mode, then operation proceeds from step 236 to the input of step 238. In step 238 the device operates the first filter to operate during a second period of time in opaque filter mode of operation. In some embodiments, the first surface is the surface of a license plate, and step 238 includes step 240, in which the device operates the first filter to be opaque to obstruct viewing of the license plate number. Operation proceeds from step 238 to the input of step 208.

Returning to step 254, in step 254 the device operates a second filter placed over a second surface displaying information to operate during a third period of time in transparent mode of operation. In some embodiments, the second surface is the surface of a plate with a number (VIN plate), sticker (inspection sticker, parking sticker, access sticker, etc.), tag, card (registration card), surface of the vehicle including marking and/or images (company name, business ID, etc.), and step 254 includes step 256, in which the device operates the second filter to be transparent to allow viewing of one of: VIN number, business name, business ID number, container number, inspection sticker information including, e.g. a QR code, a registration card, a (security, parking, event, facility, or site) access sticker tag or card. Operation proceeds from step 254 to step 258.

In step 258 the device receives one or more signals providing: i) user input, ii) control information, iii) vehicle mode of operation information, or iv) vehicle location information. Step 258 includes one or more of steps 260, 262, 264, 266 and 270. During different iterations of step 258 different ones of steps 260, 262, 264, 266, and 270 may be performed. In step 260 the device receives user input including user input controlling the second filter to switch from the transparent filter mode to the opaque filter mode. In step 262 the device receives user input including user input controlling the second filter to switch from the opaque filter mode to the transparent filter mode. In step 264 the device receives control information being communicated in a wireless signal. In step 266 the device receives mode of operation information indicating one or more of: i) the vehicle is moving or ii) the vehicle is parked. In some embodiments, step 266 includes step 268 in which the device receives one or more signals indicating that the vehicle is parked. In step 260 the device receives location information, e.g., from a GPS receiver included in the vehicle or from a navigation system included in the vehicle. Operation proceeds from step 258 to step 272.

In step 272 the device determines, e.g., using a processor or control circuit, based on the received one or more signals, whether the second filter is to operate in the transparent mode of operation or the opaque mode of operation, the mode of operation in which the second filter is to operate being a determined mode of operation. Step 272 may, and sometimes does, include step 274, in which the device operates processing on the vehicle to control the mode of second filter operation based on whether or not the vehicle is parked. Each iteration of step 272 includes one of steps 278 and 280. In step 228 the device determines that the second filter is to operate in transparent filter mode of operation. In step 280 the device determines that the second filter is to operate in opaque filter mode of operation. Operation proceeds from step 272 to step 282.

In step 282 it is determined if the current filter mode of operation for the second filter is different from the determined filter mode of operation for the second filter. If the current filter mode of operation is different than the determined filter mode of operation, then operation proceeds from step 282 to step 284; otherwise, operation proceeds from step 282 to step 286.

In step 284, the device controls the second filter to change from the current mode of operation to the determined mode of operation. Operation proceeds from step 284 to step 286.

In step 286, if the determined mode of operation is transparent filter mode, then operation proceeds from step 286 to the input of step 254. However, in step 286, if the determined mode of operation is opaque filter mode, then operation proceeds from step 286 to the input of step 288. In step 288 the device operates the second filter to operate during a fourth period of time in opaque filter mode of operation. In some embodiments, the second surface is the surface of a plate with a number (VIN plate), sticker (inspection sticker, parking sticker, access sticker, etc.), tag, card (registration card), surface of the vehicle including marking and/or images (company name, business ID, etc.), and step 288 includes step 290, in which the device operates the second filter to be opaque to prevent viewing of one of: VIN number, business name, business ID number, container number, inspection sticker information including, e.g. a QR code, a registration card, a (security, parking, event, facility, or site) access sticker tag or card. Operation proceeds from step 288 to the input of step 258.

Returning to step 304, in step 304 the device operates a third filter positioned in a first window area to operate during a fifth period of time in transparent mode of operation. In some embodiments, step 304 includes step 306 in which the device operates the third filter to be transparent to allow viewing into the vehicle. Operation proceeds from step 304 to step 308.

In step 308 the device receives one or more signals providing: i) user input, ii) control information, iii) vehicle mode of operation information, or iv) vehicle location information. Step 308 includes one or more of steps 310, 312, 314, 316 and 320. During different iterations of step 308 different ones of steps 310, 312, 314, 316, and 320 may be performed. In step 310 the device receives user input including user input controlling the third filter to switch from the transparent filter mode to the opaque filter mode. In step 312 the device receives user input including user input controlling the third filter to switch from the opaque filter mode to the transparent filter mode. In step 314 the device receives control information being communicated in a wireless signal. In step 316 the device receives mode of operation information indicating one or more of: i) the vehicle is moving or ii) the vehicle is parked. In some embodiments, step 316 includes step 318 in which the device receives one or more signals indicating that the vehicle is parked. In step 320 the device receives location information, e.g., from a GPS receiver included in the vehicle or from a navigation system included in the vehicle. Operation proceeds from step 308 to step 322.

In step 322 the device determines, e.g., using a processor or control circuit, based on the received one or more signals, whether the third filter is to operate in the transparent mode of operation or the opaque mode of operation, the mode of operation in which the third filter is to operate being a determined mode of operation. Step 322 may, and sometimes does, include step 324, in which the device operates processing on the vehicle to control the mode of filter operation of the third filter based on whether or not the vehicle is parked. Each iteration of step 322 includes one of steps 328 and 330. In step 328 the device determines that the third filter is to operate in transparent filter mode of operation. In step 330 the device determines that the third filter is to operate in opaque filter mode of operation. Operation proceeds from step 322 to step 332.

In step 332 it is determined if the current filter mode of operation for the third filter is different from the determined filter mode of operation for the third filter. If the current filter mode of operation is different than the determined filter mode of operation, then operation proceeds from step 332 to step 334; otherwise, operation proceeds from step 332 to step 336.

In step 334, the device controls the third filter to change from the current mode of operation to the determined mode of operation. Operation proceeds from step 334 to step 336.

In step 336, if the determined mode of operation is transparent filter mode, then operation proceeds from step 336 to the input of step 304. However, in step 336, if the determined mode of operation is opaque filter mode, then operation proceeds from step 336 to the input of step 338. In step 338 the device operates the third filter to operate during a sixth period of time in opaque filter mode of operation. In some embodiments, step 338 includes step 340, in which the device operates the third filter to be opaque to obstruct viewing into the vehicle. Operation proceeds from step 338 to the input of step 308.

Returning to step 354, in step 354 the device operates a fourth filter positioned in a second window area to operate during a seventh period of time in transparent mode of operation. In some embodiments, step 354 includes step 356 in which the device operates the fourth filter to be transparent to allow viewing into the vehicle. Operation proceeds from step 354 to step 358.

In step 358 the device receives one or more signals providing: i) user input, ii) control information, iii) vehicle mode of operation information, or iv) vehicle location information. Step 358 includes one or more of steps 360, 362, 364, 366 and 370. During different iterations of step 358 different ones of steps 360, 362, 364, 366, and 370 may be performed. In step 360 the device receives user input including user input controlling the fourth filter to switch from the transparent filter mode to the opaque filter mode. In step 362 the device receives user input including user input controlling the fourth filter to switch from the opaque filter mode to the transparent filter mode. In step 364 the device receives control information being communicated in a wireless signal. In step 366 the device receives mode of operation information indicating one or more of: i) the vehicle is moving or ii) the vehicle is parked. In some embodiments, step 366 includes step 368 in which the device receives one or more signals indicating that the vehicle is parked. In step 370 the device receives location information, e.g., from a GPS receiver included in the vehicle or from a navigation system included in the vehicle. Operation proceeds from step 358 to step 372.

In step 372 the device determines, e.g., using a processor or control circuit, based on the received one or more signals, whether the fourth filter is to operate in the transparent mode of operation or the opaque mode of operation, the mode of operation in which the fourth filter is to operate being a determined mode of operation. Step 372 may, and sometimes does, include step 374, in which the device operates processing on the vehicle to control the mode of filter operation of the fourth filter based on whether or not the vehicle is parked. Each iteration of step 372 includes one of steps 378 and 380. In step 388 the device determines that the fourth filter is to operate in transparent filter mode of operation. In step 380 the device determines that the fourth filter is to operate in opaque filter mode of operation. Operation proceeds from step 372 to step 382.

In step 382 it is determined if the current filter mode of operation for the fourth filter is different from the determined filter mode of operation for the fourth filter. If the current filter mode of operation is different than the determined filter mode of operation, then operation proceeds from step 382 to step 384; otherwise, operation proceeds from step 382 to step 386.

In step 384, the device controls the fourth filter to change from the current mode of operation to the determined mode of operation. Operation proceeds from step 384 to step 386.

In step 386, if the determined mode of operation is transparent filter mode, then operation proceeds from step 386 to the input of step 354. However, in step 386, if the determined mode of operation is opaque filter mode, then operation proceeds from step 386 to the input of step 388. In step 388 the device operates the fourth filter to operate during an eight period of time in opaque filter mode of operation. In some embodiments, step 388 includes step 380, in which the device operates the fourth filter to be opaque to obstruct viewing into the vehicle. Operation proceeds from step 388 to the input of step 358.

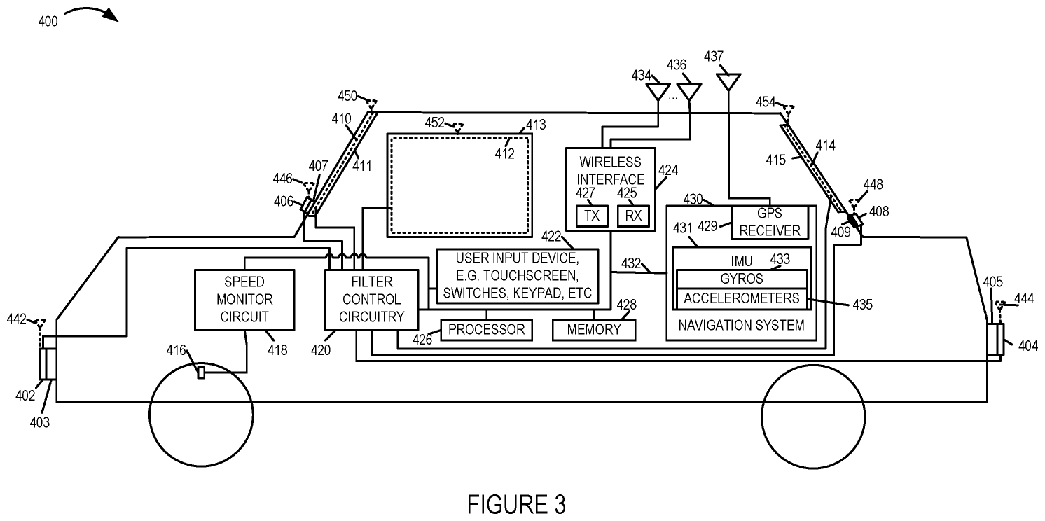

FIG. 3 is a drawing of an exemplary vehicle 400 including a plurality of controllable filters (front license plate viewing controllable filter 402, rear license plate viewing controllable filter 404, front windshield decal/tag/VIN viewing controllable filter 406, rear decal/tag/marking viewing controllable filter 408, front window filter 410, side window filter 412, rear window filter 414) in accordance with an exemplary embodiment. Front license plate viewing controllable filter 402 covers the front license plate 403. Rear license plate viewing controllable filter 404 covers the rear license plate 405. Front windshield decal/tag/VIN viewing controllable filter 406 covers front windshield's decal, tag, or VIN plate 407. Rear decal/tag/marking viewing controllable filter 408 covers the decal, tag, or marking 409 on the rear of the vehicle. Front window filter 410, included on top of or as part of the windshield 411 can, and sometimes does, restrict viewing into the vehicle. Side window filter 412, included on top of or as part of the side window 413 can, and sometimes does, restrict viewing into the vehicle. Rear window filter 414, included on top of or as part of the back window 415 can, and sometimes does, restrict viewing into the vehicle.

Exemplary vehicle 400 further includes a speed sensor 416 coupled to speed control circuit 418 for monitoring vehicle speed, filter control circuitry 420 coupled to each of the controllable filters (402, 404, 406, 408, 410, 412, 414), a user input device 422, e.g., a touch screen display, switches, a keypad, etc., for receiving user input (e.g., with regard to desired filter settings) from the vehicle operator, a wireless interface 424 including a wireless receiver 425 and wireless transmitter 427, e.g. supporting cellular, WiFi, Bluetooth, and/or other communications protocols, e.g., for receiving control signals with regard to filter control, a processor 426, e.g., a CPU, memory 428 including rules, procedures and operations to be followed, regarding determining filter mode of operation for each filter and changing filter mode of operation, and a navigation system 430 including a GPS receiver 429 and an inertial measurement unit (IMU) 431, e.g. IMU on a chip, including gyroscopes 433 and accelerometers 435. The various elements 418, 420, 422, 424, 426, 428, and 430 are coupled together via a bus 432 over which the various elements may interchange data and information. The wireless interface 424 is coupled to one or more antennas 434, . . . , 426, via which the vehicle's CPU 426 may communicate with other devices, e.g., control devices which can control the controllable filters, via wireless signals. The GPS receiver 429 is coupled to a GPS antenna 437 for receiving GPS signals from satellites, used to determine time, GPS position, and velocity information. In some embodiments, one or more of all of the controllable filters (402, 404, 406, 408, 410, 412, 414) includes its own antenna (442, 444, 446, 448, 450, 452, 454) for receiving wireless control signals.

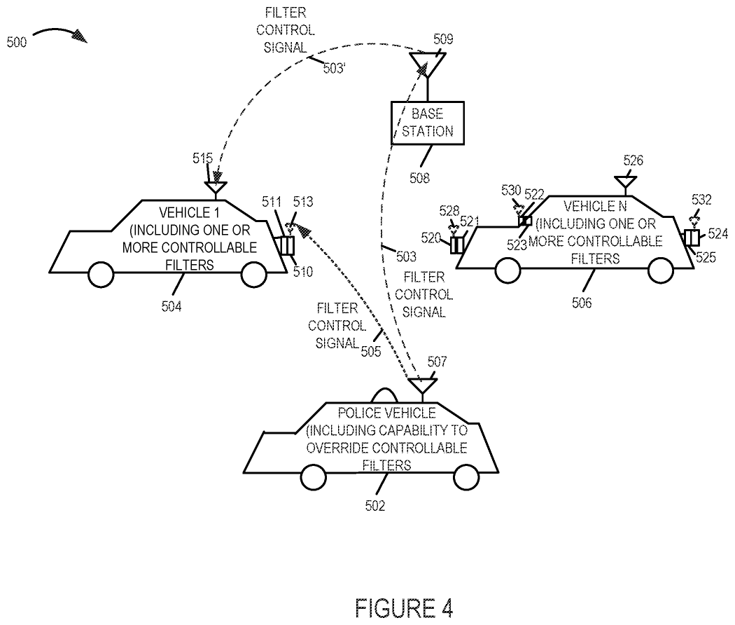

FIG. 4 is a drawing 500 illustrating a police vehicle 502 including the capability to override controllable filters, a plurality of vehicles (vehicle 1 504, vehicle N 506), each vehicle including one or more controllable filters. Vehicle 1 504 includes rear license plate filter 510 which covers rear license plate 511. Vehicle N 506 506 includes front license plate filter 520 which covers front license plate 521, front window filter 522 which covers front window decal 523, and rear license plate filer 524 which covers rear license plate 525. Vehicle 1 504 includes antennas 513, 515. Vehicle 2 506 includes antennas 526, 528, 530, 532.

Police vehicle 502 generates and transmits a wireless filter control signal 503 or a wireless control signal 505, said wireless control signal (503, 505) including a command message directed to a vehicle 504 including a controllable filter 510, said control command message overriding the current setting of the controllable filter 508 and causing the controllable filter 510 to operate in transparent filter mode. In this example the controllable filter 510 is a filter which can block out viewing of the rear license plate 511 when in opaque mode of operation.

In a first approach exemplary signal 503, which includes a control message to command controllable filter 510 to transparent mode is sent from police vehicle 502, via antenna 507, to a base station 508 which receives the signal 503 via antenna 509 and then resends the command control message 503, via antenna 509, as downlink signal 503′ to vehicle 504, and signal 503′ is received via antenna 515 of vehicle 504.

In a second approach exemplary signal 505, which includes a control message to command controllable filter 510 to transparent mode is sent directly from police vehicle 502 to vehicle 504, e.g., via a short range communications protocol, e.g. Bluetooth. In some embodiments, an antenna 513 is included as part of controllable filter 510 for receiving the command control signal 505.

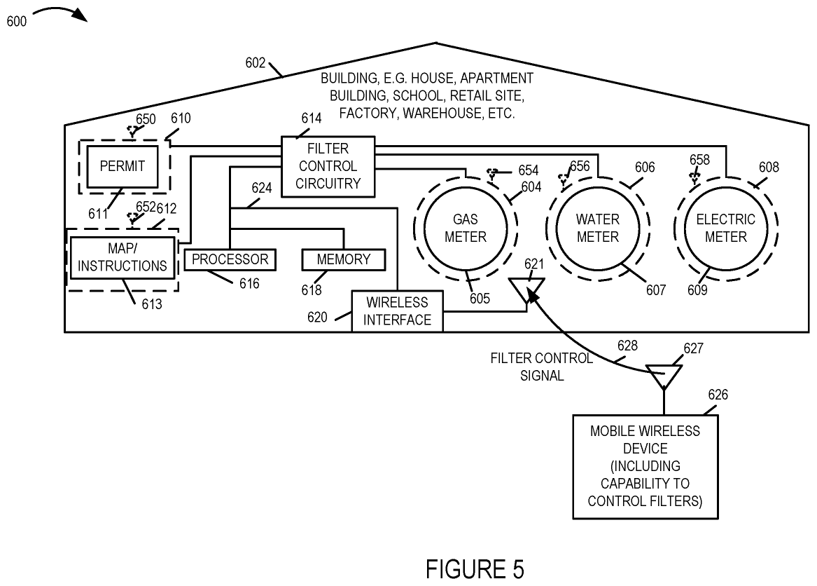

FIG. 5 is a drawing 600 illustrating a mobile wireless device 626 sending a wireless filter control signal 628 to control a home site controllable filter (one of controllable filters 608, 606, 604, 610, 612) to operate in transparent filter mode. Drawing 600 illustrates an exemplary building 602, e.g., a house, apartment building, school, retail site building, factory, warehouse, etc., which includes a plurality of controllable filters (electric meter viewing controllable filter 608 covering electric meter display 609, water meter viewing controllable filter 606 covering water meter display 607, gas meter viewing controllable filter 604 covering gas meter display 605, permit viewing controllable filter 610 covering permit 611, and map/instruction viewing controllable filter 612 covering map/instructions 613. Each of the controllable filters (608, 606, 604, 610, 612 are coupled to filter control circuitry 614. Building 602 further includes a processor 616, e.g., a CPU, memory 618, and wireless interface 620 including a wireless receiver and a wireless transmitter. The various elements 614, 616, 618, 620, 622 are coupled together via bus 624 over which the elements may exchange data and information. Wireless interface 620 is coupled to antenna 621 via which the wireless interface 620 may receive and transmit wireless signals, e.g., from and to mobile wireless control device 626, e.g., a control device belonging to a meter reader, inspector, government official, or emergency responder. In some embodiments, one or more of all of the controllable filters (608, 606, 604, 610, 612) includes its own antenna (658, 656, 654, 650, 652) for receiving and/or transmitting wireless control signals, e.g., from to a control device, e.g., mobile wireless control device 626 including antenna 627.

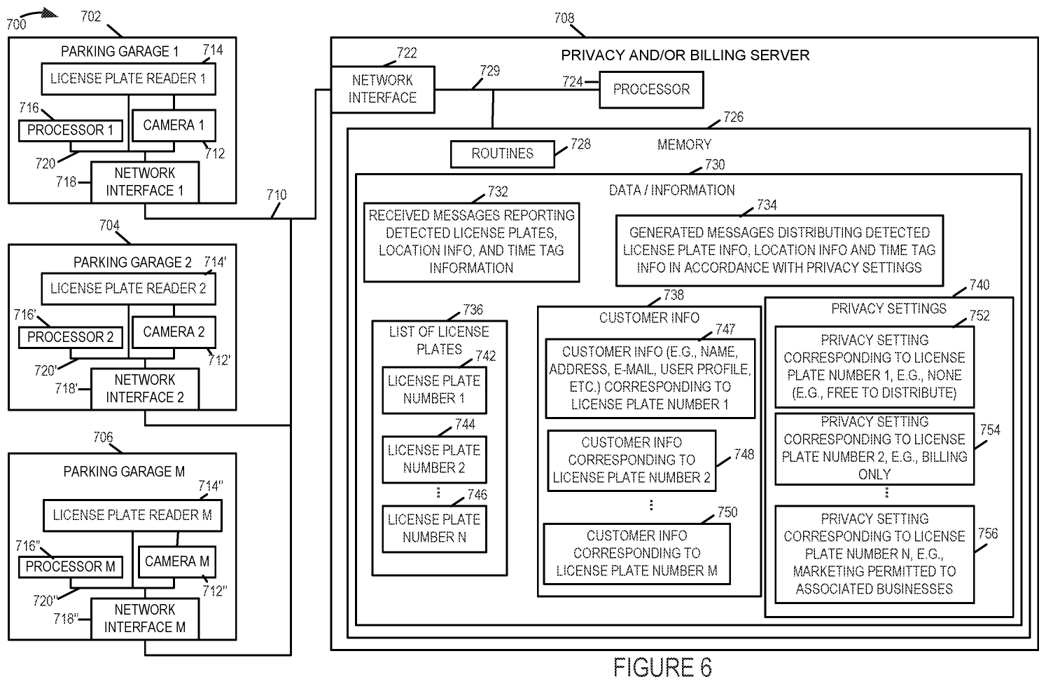

FIG. 6 is a drawing 700 illustrating a plurality of parking garages (702, 704, 706), including cameras and license plate readers, coupled to a privacy and/or billing server 708, which processes received information corresponding to captured license plates and uses and/or distributes the information in accordance with stored privacy settings in accordance with an exemplary embodiment. Exemplary parking garage 1 702 includes camera 1 712, license plate reader 1 714, processor 1 716, e.g., a CPU, and network interface 1 718 coupled together via bus 720 over which the various elements may interchange data and information. Exemplary parking garage 2 704 includes camera 2 712′, license plate reader 2 714′, processor 2 716′, e.g., a CPU, and network interface 2 718′ coupled together via bus 720′ over which the various elements may interchange data and information. Exemplary parking garage M 706 includes camera M 712″, license plate reader M 714″, processor M 716″, e.g., a CPU, and network interface M 718″ coupled together via bus 720″ over which the various elements may interchange data and information. The parking garages (702, 704, 706) are coupled, via their interfaces (718, 718′, 718″), respectively, and bus 710 to privacy and/or billing server 708.

Privacy and/or billing server 708 includes a network interface 722, a processor 724, e.g., a CPU, and memory 726 coupled together via a bus 729 over which the various elements (722, 724, 726) may interchange data and information. Memory 726 includes routines 728 and data/information 730. Data/information 730 includes received messages reporting detected license plates, location information, and time tag information, generated messages 734 distributing detected license plate information, location information and time tag information in accordance with privacy settings. Data information 730 further includes a list of license plates 736, customer information 738, and privacy setting information 740. Exemplary list of license plates 736 includes license plate number 1 742, license plate number 2 744, . . . , license plate number N 746. Exemplary customer information 738 includes customer information 747, e.g., a name, an address, an E-mail, a user profile, etc., corresponding to license plate number 1, customer information 748 corresponding to license plate number 2, and customer information 750 corresponding to license plate number M. Exemplary privacy settings information 740 includes a privacy setting corresponding to license plate number 1 752, e.g. none (e.g., signifying free to distribute), a privacy setting corresponding to license plate number 2 754, e.g. billing only, and a privacy setting corresponding to license plate number N 756, e.g. marketing permitted to associated businesses.

In addition to providing a method and apparatus for reducing the risk that license plate information will be captured, various features are directed to a system for providing an entity, e.g., individual or company, the ability to set restrictions on the use of the license plate number information and/or information associated with an entity's vehicle license plate number.

In various embodiments, billing of the license plate holder for parking related services is implemented by the billing server without the parking garage operator being provided access to the license plate holder information stored in the license plate billing and privacy server.

The methods and apparatus address the technical problem of how to provide parking and/or billing services based on license plate number information without having to share billing information and/or other personal details with a parking garage. In addition, the methods and apparatus, at least in some embodiments, allow a license plate holder to express privacy intentions and/or set restrictions on use of license plate number and/or related information without having to know the identity of the parties capturing license plate information or the fact that license plate information was captured.

In various embodiments license plate holder, e.g., user's of motor vehicles can register their license plate number with a registration service, e.g., a license plate privacy system which in some embodiments is implemented as an Internet connected server. The license plate privacy system may be, and in some embodiments is, part of a parking garage billing system. The license plate holder can also provide billing information, e.g., credit card or payment service information which can and sometimes is associated in the license plate information data base. License plate holder name, address, and telephone information may be, and sometimes is, also associated with the license plate number in the registration system. The billing information can be, and in some embodiments is, kept confidential and not shared with a parking garage operator. However, the parking garage operator may report detection of a license plate number along with entry and/or vehicle exit times to the billing/privacy system. The system, implemented as a server in some embodiments, bills the holder of the license plate of the parking service provided, e.g., based on the date, entrance and/or exit times reported by the parking garage using the billing and/or privacy service. In various embodiments, while the license plate holder is billed by the billing/parking service the parking garage is not provided with the customer's, e.g., license plate holder billing information and may not, depending on the privacy setting associated with the license plate number be provided with information identity and/or home address of the license plate holder. The license plate based billing/privacy system can allow a user to register for one or more services to be charged based on license plate number detection knowing that the license plate holders billing and personal information will not be shared, in the case where information sharing is restricted by the license plate holder, with the company or entity reporting license plate detection and seeking payment for services rendered. In addition to license plate number and entry/exit time information (or simply license plate image capture time information in some cases) an image of the vehicle on which the reported license plate is mounted, is also sent to the billing system as evidence of that the vehicle with the indicated license plate number was in fact at the facility on the date/time reported to the billing system. Such images when sent and stored by the billing/privacy system can be used to confirm reported license plate detection when provided to the system since in at least some embodiments geolocation and time stamp information is embedded into the digital images sent with billing messages or as proof of detection of a license plate number as evidence of parking facility use.

The billing and privacy system can be used to provide billing services to multiple garages which are independently owned but also to car wash operators and/or other vehicle service providers. Accordingly, the methods and apparatus can be used to allow independent service operators to bill for services based on detected license plate numbers without the independent service operators having to have access to the customer's billing information or even be aware of the name or home address of the customer.

Thus in at least some embodiments parking garages contact the system when they detect, e.g., using a camera, a license plate of a vehicle and provide time of detection and whether the detection is associated with a parking lot entry or exit event as maybe determined by whether the license plate number was captured by a camera at an entrance or exit to the parking garage.

The system uses the license plate number and entry/exit information for billing purposes. E.g., the time of entry of a parking garage located at a particular geographic location is stored, the time of exit from the parking garage is also stored and an amount to be billed for use of the garage is determined based on the entry and exits times and/or whether the entity associated with the detected license plate number has purchased a monthly, weekly or daily parking permit or license for the garage being used.

While the billing and privacy system can be used to support secure and private billing for services based on license plate number information the system can also be used for license plate holders who do not want to use it for billing services to register information indicating a desire that their license plate number not be used for tracking, marketing and/or information sale or information distribution purposes. Accordingly with regard to one or more users the system operates simply as a privacy system to store and communicate to individuals detecting the user's license plate number the license plate holder's desire that their privacy be respected and that their license plate number not be used for one or more purposes, e.g., marketing information and/or location tracking purposes.

In some embodiment's a name, home or business address, and optionally billing information is associated with license plate number stored in a database, e.g., list or set of license plate records, in the system. Multiple license plate holders can store their license plate numbers and corresponding privacy preferences.

In various embodiments information about the vehicle location is stored and communicated to one or more entities. The entities may be parking garage owners but in some cases entities that do not operate a parking garage but who are willing to pay for information that can be used for law enforcement purposes, location determination purposes, e.g., vehicle tracking and location determination, and/or for marketing purposes. For example, businesses in an area may be willing to pay for information about individuals who routinely visit a particular area, e.g., where a parking garage is located so that they can target promotions, advertisements towards the individuals or vehicle user's who frequent an area.

In accordance with the invention, the system allows a user, e.g., license plate holder, to set restrictions on what his/her license plate number information can be used for. In some cases, the user indicates that the license plate number information can be used for parking garage services, e.g., billing, charging and/or determining of a right to use a parking garage or spot but not for other purposes. License plate number and associated information for individuals who do not set a privacy setting is, in some embodiments, automatically set to a default unrestricted setting. In the case where a privacy setting is unrestricted, license plate number and/or related information is allowed to be shared, sold and/or provided to other businesses and/or entities, e.g., for marking and/or tracking purposes. Law enforcement is allowed access to the parking and license plate information as required by any law or legal court order.

While the license plate number registration system is well suited for parking garages it can be used by any of a wide range of service providers and/or entities that capture and user license plate number information including parking garage operators but also user's with cameras set up to capture license plate numbers as vehicles pass by a camera system, e.g., located on private property along a side of a road for instance. An individual or business entity and enter license plate number information into the database and indicate that the license plate number be treated as a private number with one or use restrictions. In this way a license plate user can store in the privacy system license plate information restriction information and/or permissions. The register can, in effect, be used as a “do not share” information indicator to one or more entities which capture license plate numbers and can contact the system to determine license plate holder preferences or information restrictions set by the license plate holder.

Thus, in various embodiments a list or register is used to associate with a registered license plate number whether or not the license plate holder wants to restrict dissemination of information associated with the license plate number. User's registering their number with the license plate registration service may and in some embodiments do, pay a fee to the registration service. Alternatively, parking garages and/or other entities which capture license plate numbers may, and sometimes do, pay a fee to be allowed to determine if a license plate holder has set a do not share information restriction.

Parking garages and/or other systems which capture images and thus license plate numbers can check with the registration, e.g., privacy system, to determine if an entity, e.g., license plate holder, has indicated their desire to maintain privacy and avoid dissemination of information based on the capture of an image including a registered license plate number and/or detection of the license plate number.

License plate information may be used for a variety of acceptable purposes, e.g., identifying a vehicle for law enforcement purposes or for controlling access to a parking garage. An entity, e.g., individual or company with which a license plate is associated, may, and sometimes does, consent to the use of his license plate number information for particular purposes such as for controlling access to a parking garage. The consent may be explicit in a parking agreement or implicit by a user providing the license plate number information in addition to his/her contact information when renting a parking space, e.g., on a monthly basis or some other basis.

The license plate registration/privacy system may be viewed as something similar to a “do not call list” where individuals can register their license and express an indication that the license plate number not be used for targeting advertisements and or other marketing campaigns that may involve license plate holder information and/or attempts to contact the license plate holder or to track the license plate holder.

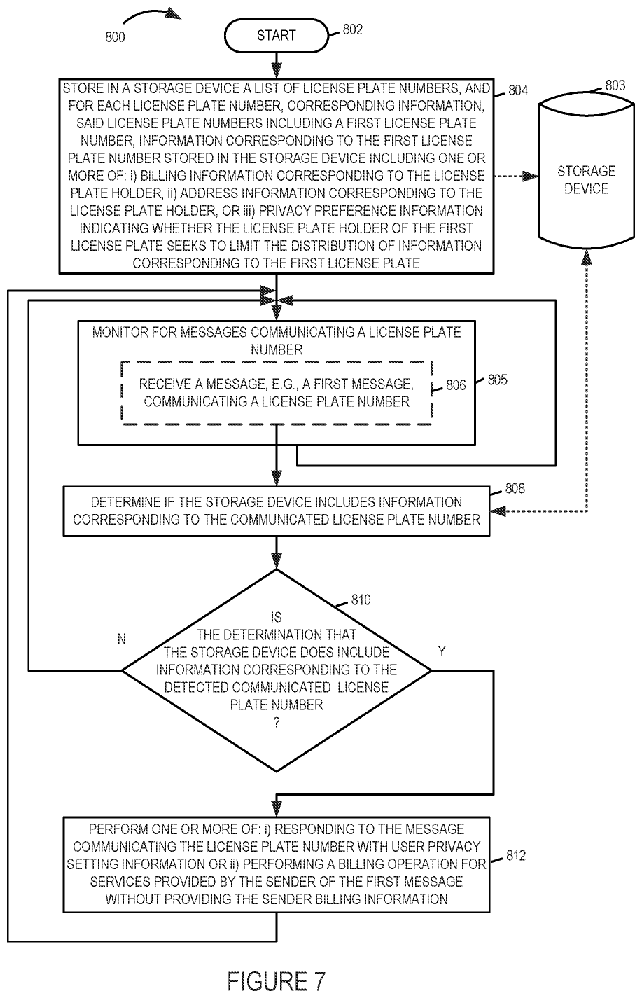

FIG. 7 is a flowchart 800 of an exemplary method of storing and using information associated with a vehicle license plate number in accordance with an exemplary embodiment. The exemplary method of flowchart 800 is performed, e.g., by a server, e.g. privacy and/or billing server 708 of system 700 of FIG. 6.

Operation starts in step 802 in which the server is powered on and initialized. Operation proceeds from start step to step 804. In step 804, the server stores in a storage device 803 (e.g., memory or disc storage) a list of license plate numbers, and for each license plate number, corresponding information, said license plate numbers including a first license plate number, information corresponding to the first license plate number stored in the storage device including one or more or all of: i) billing information corresponding to the license plate holder, ii) address information corresponding to the license plate holder, and/or iii) privacy preference information indicating whether the license plate holder of the first license plate seeks to limit the distribution of information corresponding to the first license plate (e.g., whether information associated with the license plate can be provided to other entities and/or the license plate holder does not want anyone who detects the license plate to use it for marketing and/or location tracking purposes). In some embodiments, storage device 803 is memory 706 of server 708 of system 700. In some other embodiments, storage device 803 is a separate storage device, e.g., an external memory, coupled to server 708 of system 700. Operation proceeds from step 804 to step 805.

In step 805 the server monitors for messages communicating a license plate number (e.g., in a communicated captured image or in the form of a number which was determined from a captured image and communicated in number form), e.g., repetitively, on an ongoing basis. Step 805 may, and sometimes does, include step 806. In step 806 the server receives a message, e.g., a first message, communicating a license plate number. Operation proceeds from step 806 to step 808.

In step 808 the server determines if the storage device includes information corresponding to the communicated license plate number. Operation proceeds from step 808 to step 810.

In step 810, if the server determined that the storage device does not include information corresponding to the detected communicated license plate number, then operation proceeds from step 810 to the input of step 805, for additional monitoring. However, in step 810 if the server determined that the storage device does include information corresponding to the detected communicated license plate number, then operation proceeds from step 810 to step 812.

In step 812 the server performs one or more of: i) responding to the message communicating the license plate number with user privacy setting information (e.g., whether or not the license plate number corresponds to a number for which a user has set a privacy restriction such as prohibiting use of license plate number detection information for marketing and/or targeted advertising purposes or location tracking) or ii) performing a billing operation for services provided by the sender of the first message with providing the sender billing information (and in some cases without providing license plate holder identification information to the sender of the first message). In some embodiments, responding to the message communicating the license plate number with user privacy setting includes sending a response message to the sender of the first message indicating that the sender should not use the information associated with the license plate number communicated in the first message (e.g., for marketing or license plate holder tracking). Operation proceeds from step 812 to the input of step 805, for additional monitoring.

In some embodiments, the sender of the first message is a parking garage operator. In some embodiments, the sender of the first message is a car service provider (e.g., car wash operator or car repair service provider such as a mechanic).

### FIRST NUMBERED LIST OF EXEMPLARY METHOD EMBODIMENTS

Method Embodiment 1. A privacy protection method, the method comprising: operating (204) a first filter placed over a first surface displaying information to operate during a first period of time in transparent filter mode of operation; and operating (238) the first filter to operate during a second period of time in opaque filter mode of operation.

Method Embodiment 1A. The method of Method Embodiment 1, wherein the first filter is a filter positioned over a license plate that includes a license plate number; wherein operating (204) the first filter to operate in the first mode of operation includes operating (206) the first filter to be transparent to allow viewing of said license plate number; and wherein operating (238) the first filter to operate during the second period of time includes: operating (240) the first filter to obstruct viewing of the license plate number.

Method Embodiment 1B. The method of Method Embodiment 1, wherein said filter is powered by a vehicle battery or vehicle power supply system and wherein said filter is controlled by a processor which receives information from one or more vehicle systems (e.g., GPS systems or vehicle speed control systems) which supply information on i) vehicle location, ii) vehicle speed, iii) parking brake status, iv) a vehicle wireless communications system (e.g., cellular, WiFi and/or Bluetooth system).

Method Embodiment 2. The method of Method Embodiment 1, wherein said first surface displaying information is a surface of: i) a vehicle license plate, ii) a vehicle identification number (VIN) plate, iii) the vehicle, trailer or cargo container (e.g., business name, identification number, or cargo container number on back or side of truck, trailer or cargo container), iv) an inspection sticker, v) a registration card or sticker, vi) a parking sticker, parking tag or parking card, vii) a security access sticker, viii) an event access sticker, ix) a VIP access sticker, x) a facility or park access sticker, xi) a usage meter (e.g., water, gas or electric meter), xii) a permit, xiii) a building or construction related information, or xiv) a display device such as an LCD screen.

Method Embodiment 3. The method of Method Embodiment 2, wherein said filter is an LCD filter which is transparent or semi-transparent during said transparent mode of operation allowing numbers on the first surface to be viewed through said filter during the first mode of operation and opaque during the second mode of operation.

Method Embodiment 4. The method of Method Embodiment 2, wherein said surface is a surface of a vehicle license plate, said surface includes a vehicle license plate number, the method further comprising: receiving (208) one or more signals providing: i) user input, ii) control information, iii) vehicle mode of operation information or iv) vehicle location information; and determining (222), e.g., using a processor or control circuit, based on the received one or more signals, whether the first filter is to operate in the transparent filter mode of operation or the opaque filter mode of operation, the mode of operation in which the first filter is to operate being a determined mode of filter operation.

Method Embodiment 5. The method of Method Embodiment 4, further comprising: determining (232) if a current mode of first filter operation is different from the determined filter mode of operation; and in response to determining that the current mode of filter operation is different from the determined filter mode of operation controlling (234) the first filter to change from the current mode of operation to the determined filter mode of operation.

Method Embodiment 5A. The method of Method Embodiment 4, wherein receiving (208) one or more signals includes receiving user input includes receiving user input (210) controlling the filter to switch from the transparent filter mode to the opaque filter mode.

Method Embodiment 5B. The method of Method Embodiment 4, wherein receiving (208) one or more signals includes receiving user input includes receiving (212) user input controlling the filter to switch from the opaque filter mode to the transparent filter mode.

Method Embodiment 6. The method of Method Embodiment 4, wherein receiving (208) one or more signals includes receiving (214) said control information, said control information being communicated in a wireless signal (e.g., transmitted from a police vehicle or handheld device corresponding to a law enforcement entity, inspector or other individual authorized to override the filter and control it to switch to the first mode of operation to thereby allow the license plate number or other information obscured by the filter when operating in the second mode of operation to become visible).

Method Embodiment 7. The method of Method Embodiment 4, wherein receiving (208) one or more signals includes receiving (216) vehicle mode of operation information (e.g., from a computer or sensor on the vehicle on which the filter is mounted) indicating one or more of: i) the vehicle is moving or ii) the vehicle is parked.

Method Embodiment 8. The method of Method Embodiment 7, further comprising:

operating a processor (224) on said vehicle to control the mode of filter operation based on the received vehicle mode of operation information (in some embodiments the filter is made transparent when the vehicle is moving, in other embodiments the filter is made opaque (e.g., to operate in second mode when the vehicle is parked), in still other embodiments the mode of vehicle operation is taken into consideration along with the location of the vehicle, e.g., whether the vehicle is on public or private property with the filter being operated in the opaque mode in some such embodiments only when on private property, and in still other embodiments, only when on private property and the vehicle is not moving).

Method Embodiment 9. The method of Method Embodiment 7, wherein receiving (208) one or more signals indicates that the vehicle is parked and wherein the method further includes: operating (224) a processor on said vehicle to control the mode of filter operation based on whether or not the vehicle is parked (e.g., the filter is operated in the second opaque mode when parked but not when the vehicle is moving).

Method Embodiment 10. The method of Method Embodiment 1, wherein said first surface displaying information is a surface (e.g., surface of a permit or other information posting or of a display device) of a physical apparatus (which could be a printed document, permit or poster, electronic display device or display portion of a physical meter such as a power or water meter) mounted on a building.

Method Embodiment 11. The method of Method Embodiment 1, further comprising: operating (254) a second filter placed over a second surface displaying information to operate during a third period of time in transparent filter mode of operation; and operating (288) the second filter to operate during a fourth period of time in opaque filter mode of operation.

Method Embodiment 11A. The method of Method Embodiment 11, wherein the first surface is a surface of: a vehicle license plate displaying a license plate number, and wherein said second surface is one of: i) a vehicle identification number (VIN) plate, ii) the vehicle, a trailer or a cargo container (e.g., business name, identification number, or cargo container number on back or side of truck, trailer or cargo container), iii) an inspection sticker, iv) a registration card or sticker, v) a parking sticker, parking tag or parking card, vi) a security access sticker, vii) an event access sticker, viii) a VIP access sticker, ix) a facility or park access sticker, or x) a display device such as an LCD screen.

Method Embodiment 11B. The method of Method Embodiment 11, wherein the first surface is a surface of: a first usage meter (e.g., water, gas, or electric meter) and wherein said second surface is one of: i) a second usage meter (e.g. water, gas, or electric meter), ii) a permit, iii) building or construction related information, or iv) a display device such as an LCD screen.

Method Embodiment 12. The method of Method Embodiment 11, further comprising: operating (304) a third filter positioned in a first window viewing area to operate during a fifth period of time in transparent filter mode of operation; and operating (340) the third filter positioned in the first window viewing area to operate during a sixth period of time in opaque filter mode of operation.

Method Embodiment 12A. The method of Method Embodiment 12, wherein said first window is one of a front, side or back window of the vehicle.

Method Embodiment 12B. The method of Method Embodiment 12A, further comprising: determining a mode of filter operation for the third filter based on whether or not the vehicle is parked. (e.g., opaque mode for parked to provide security (so no one can see what is stored inside the vehicle) or for privacy).

Method Embodiment 12C. The method of Method Embodiment 12A, further comprising: determining a mode of filter operation for the third filter based on location of the vehicle ((e.g., public property (transparent) or private property (opaque) or (based on state in which vehicle is located and rules for tinted windows corresponding to the state)).

Method Embodiment 12D. The method of Method Embodiment 12C, wherein said determination of the mode of filter operation for the third filter is further based on whether the window is a front window, side window or back window (different rules in some states for different windows with regard to tinted glass.)

Method Embodiment 12D1. The method of Method Embodiment 12, further comprising: operating (304) a fourth filter positioned in a second window viewing area to operate during a seventh period of time in transparent filter mode of operation; and operating (340) the fourth filter positioned in the second window viewing area to operate during a eighth period of time in opaque filter mode of operation.

Method Embodiment 12E. The method of Method Embodiment 12D1, wherein said first window is a front window and said second window is a side window (different state rules for front windshield tinting and side window tinting).

Method Embodiment 13. The method of Method Embodiment 11, further comprising: operating (304) a second filter positioned in a first window viewing area to operate during a third period of time in transparent filter mode of operation; and operating (340) the second filter positioned in the first window viewing area to operate during a fourth period of time in opaque filter mode of operation.

Method Embodiment 13B. The method of Method Embodiment 13, wherein operating (340) the second filter positioned in the first window viewing area to operate during a fourth period of time in opaque filter mode of operation includes operating the second filter to be opaque when looking into the first window from outside the vehicle and operating the second filter to allow limited or full visibility when looking into the first window from inside the vehicle (one way opaque allows a person inside the vehicle to see outside but does not allow a person outside to see into the vehicle).

### FIRST NUMBERED LIST OF EXEMPLARY SYSTEM EMBODIMENTS

System Embodiment 1. A privacy protection system comprising: a first filter positioned over a first surface displaying information (e.g., a license plate number); and a processor configured to control the first filter to: i) operate during a first period of time in transparent filter mode of operation; and ii) operate during a second period of time in opaque filter mode of operation.

System Embodiment 1A. The system of System Embodiment 1, wherein the first filter is a filter positioned over a license plate that includes a license plate number; wherein controlling (204) the first filter to operate in the first mode of operation includes operating (206) the first filter to be transparent to allow viewing of said license plate number; and wherein controlling (238) the first filter to operate during the second period of time includes: operating (240) the first filter to obstruct viewing of the license plate number.

System Embodiment 1B. The system of System Embodiment 1, wherein said filter is powered by a vehicle battery or vehicle power supply system and wherein said filter is controlled by a processor which receives information from one or more vehicle systems (e.g., GPS systems or vehicle speed control systems) which supply information on i) vehicle location, ii) vehicle speed, iii) parking brake status, iv) a vehicle wireless communications system (e.g., cellular, WiFi and/or Bluetooth system).

System Embodiment 2. The system of System Embodiment 1, wherein said first surface displaying information is a surface of: i) a vehicle license plate; ii) a vehicle identification number (VIN) plate; iii) the vehicle, trailer or cargo container (e.g., business name, identification number, or cargo container number on back or side of truck, trailer or cargo container) iv) an inspection sticker; v) a registration card or sticker, vi) a parking sticker, parking tag or parking card; vii) a security access sticker, viii) an event access sticker, ix) a VIP access sticker, x) a facility or park access sticker, xi) a usage meter (e.g., water, gas or electric meter), xii) a permit, xiii) a building or construction related information, or xiv) a display device such as an LCD screen.

System Embodiment 3. The system of System Embodiment 2, wherein said filter is an LCD filter which is transparent or semi-transparent during said transparent mode of operation allowing numbers on the first surface to be viewed through said filter during the first mode of operation and opaque during the second mode of operation.

System Embodiment 4. The system of System Embodiment 2, wherein said surface is a surface of a vehicle license plate, said surface includes a vehicle license plate number, the system further comprising: a receiver for receiving (208) one or more signals providing: i) user input, ii) control information, iii) vehicle mode of operation information or iv) vehicle location information; and wherein the processor is further configured to determine (222), based on the received one or more signals, whether the first filter is to operate in the transparent filter mode of operation or the opaque filter mode of operation, the mode of operation in which the first filter is to operate being a determined mode of filter operation.

System Embodiment 5. The system of System Embodiment 4, wherein the processor is further configured to: determine (232) if a current mode of first filter operation is different from the determined filter mode of operation; and control (234), in response to determining that the current mode of filter operation is different from the determined filter mode of operation, the first filter to change from the current mode of operation to the determined filter mode of operation.

System Embodiment 5A. The system of System Embodiment 4, wherein said receiver receives (208) user input (210) controlling the filter to switch from the transparent filter mode to the opaque filter mode.

System Embodiment 5B. The system of System Embodiment 4, wherein said receiver is configured to receive (208) one or more signals includes receiving user input includes receiving (212) user input controlling the filter to switch from the opaque filter mode to the transparent filter mode.

System Embodiment 6. The system of System Embodiment 4, wherein the receiver includes a wireless received configured to receive control information, said control information being communicated in a wireless signal (e.g., transmitted from a police vehicle or handheld device corresponding to a law enforcement entity, inspector or other individual authorized to override the filter and control it to switch to the first mode of operation to thereby allow the license plate number or other information obscured by the filter when operating in the second mode of operation to become visible).

System Embodiment 7. The system of System Embodiment 4, wherein said receiver is configured to receive (208) one or more signals includes receiving (216) vehicle mode of operation information (e.g., from a computer or sensor on the vehicle on which the filter is mounted) indicating one or more of: i) the vehicle is moving or ii) the vehicle is parked.

System Embodiment 8. The system of System Embodiment 7, wherein the processor (224) is mounted on said vehicle and is configured to control the mode of filter operation based on received vehicle mode of operation information (in some embodiments the filter is made transparent when the vehicle is moving, in other embodiments the filter is made opaque (e.g., to operate in second mode when the vehicle is parked), in still other embodiments the mode of vehicle operation is taken into consideration along with the location of the vehicle, e.g., whether the vehicle is on public or private property with the filter being operated in the opaque mode in some such embodiments only when on private property and, in still other embodiments, only when on private property and the vehicle is not moving).

System Embodiment 9. The system of System Embodiment 7, wherein said receiver is configured to receive (208) one or more signals indicating that the vehicle is parked and wherein said processor (224) on said vehicle is configured to control the mode of filter operation based on whether or not the vehicle is parked (e.g., the filter is operated in the second opaque mode when parked but not when the vehicle is moving).

System Embodiment 10. The system of System Embodiment 1, wherein said first surface displaying information is a surface (e.g., surface of a permit or other information posting or of a display device) of a physical apparatus (which could be a printed document, permit or poster, electronic display device or display portion of a physical meter such as a power or water meter) mounted on a building.

System Embodiment 11. The system of System Embodiment 1, further comprising: a second filter placed over a second surface that displays additional information; and wherein the processor (224) is further configured to control the second filter to: i) operate during a third period of time in transparent filter mode of operation; and ii) operate during a fourth period of time in opaque filter mode of operation.

System Embodiment 11A. The system of System Embodiment 11, wherein the first surface is a surface of: a vehicle license plate displaying a license plate number, and wherein said second surface is one of: i) a vehicle identification number (VIN) plate; ii) the vehicle, a trailer or a cargo container (e.g., business name, identification number, or cargo container number on back or side of truck, trailer or cargo container) iii) an inspection sticker; iv) a registration card or sticker, v) a parking sticker, parking tag or parking card; vi) a security access sticker, vii) an event access sticker, viii) a VIP access sticker, ix) a facility or park access sticker, or x) a display device such as an LCD screen.

System Embodiment 11B. The method of System Embodiment 11, wherein the first surface is a surface of: a first usage meter (e.g., water, gas, or electric meter) and wherein said second surface is one of: i) a second usage meter (e.g. water, gas, or electric meter), ii) a permit, iii) building or construction related information, or iv) a display device such as an LCD screen.

System Embodiment 12. The system of System Embodiment 11, further comprising: a third filter positioned in a first window viewing area; and wherein the processor is further configured to: operate the third filter in a transparent filter mode of operation during a fifth period of time; and operate (340) the third filter in opaque filter mode of operation during a sixth period of time.

System Embodiment 12A. The system of System Embodiment 12, wherein said first window is one of a front, side or back window of the vehicle.

System Embodiment 12B. The system of System Embodiment 12A, wherein the processor is further configured to: determine a mode of filter operation for the third filter based on whether or not the vehicle is parked. (e.g., opaque mode for parked to provide security (so no one can see what is stored inside the vehicle) or for privacy).

System Embodiment 12C. The system of System Embodiment 12A, wherein the processor is further configured to: determine a mode of filter operation for the third filter based on location of the vehicle ((e.g., public property (transparent) or private property (opaque) or (based on state in which vehicle is located and rules for tinted windows corresponding to the state)).

System Embodiment 12D. The system of System Embodiment 12C, wherein said determination of the mode of filter operation for the third filter is further based on whether the window is a front window, side window or back window (different rules in some states for different windows with regard to tinted glass.)

System Embodiment 12D1. The system of System Embodiment 12, further comprising: a fourth filter positioned in a second window viewing area; and wherein the processor is further configured to: operate the fourth filter during a seventh period of time in transparent filter mode of operation; and operate (340) the fourth filter positioned in the second window viewing area in opaque filter mode of operation during an eighth period of time.

System Embodiment 12E. The system of System Embodiment 12D1, wherein said first window is a front window and said second window is a side window (different state rules for front windshield tinting and side window tinting).

System Embodiment 13. The system of System Embodiment 11, further comprising: a second filter positioned in a first window viewing area; and wherein the processor is further configured to: operate (304) the second filter during a third period of time in transparent filter mode of operation; and operate (340) the second filter during a fourth period of time in opaque filter mode of operation.

System Embodiment 13B. The system of System Embodiment 13, wherein operating (340) the second filter positioned in the first window viewing area to operate during a fourth period of time in opaque filter mode of operation includes operating the second filter to be opaque when looking into the first window from outside the vehicle and operating the second filter to allow limited or full visibility when looking into the first window from inside the vehicle (one way opaque allows a person inside the vehicle to see outside but does not allow a person outside to see into the vehicle).

### SECOND NUMBERED LIST OF EXEMPLARY METHOD EMBODIMENTS

Method Embodiment 1. A method for storing and using information associated with a vehicle license plate number, the method comprising: storing (804) in a storage device (e.g., memory or disc storage) a list of license plate numbers and, for each license plate number corresponding information, said license plate numbers including a first license plate number, information corresponding to the first license plate number stored in said storage device including one or more of: i) billing information corresponding to the license plate holder; ii) address information corresponding to the license plate holder, and/or iii) privacy preference information indicating whether the license plate holder of the first license plate seeks to limit the distribution of information corresponding to the first license plate (e.g., whether information associated with the license plate can be provided to other entities and/or the license plate holder does not want anyone who detects the license plate to use it for marketing and/or location tracking purposes); monitoring (805) for messages communicating a license plate number (e.g., in a captured image or in the form of a number which was determined from a captured image and communicated in number form); and in response to receiving (806) a first message communicating a license plate number, determining (808) if the storage device includes information corresponding to the communicated license plate number.

Method Embodiment 2. The method of Method Embodiment 1, further comprising: in response to determining (810, Y) that the storage device includes information corresponding to the communicated license plate number performing (812) one or more of: i) responding to the message communicating the license plate number with user privacy setting information (e.g., whether or not the license plate number corresponds to a number for which a user has set a privacy restriction such as prohibiting use of license plate number detection information for marketing and/or targeted advertising purposes or location tracking) or ii) performing a billing operation for services provided by the sender of the first message without providing the sender billing information (and in some cases without providing license plate holder identification information to the sender of the first message).

Method Embodiment 3. The method of Method Embodiment 2, wherein the sender of the first message is a parking garage operator.

Method Embodiment 4. The method of Method Embodiment 3, wherein the sender of the first message is a car service provider (e.g., car wash operator or car repair service provider such as a mechanic).

Method Embodiment 5. The method of Method Embodiment 1, responding to the message communicating the license plate number with user privacy setting information is performed and includes sending a response message to the sender of the first message that they should not use information associated with the license plate number communicated in said first message (e.g., for marketing or license plate holder tracking).

### SECOND NUMBERED LIST OF EXEMPLARY SYSTEM EMBODIMENTS

System Embodiment 1. A system for storing and using information associated with a vehicle license plate number, the system comprising:

a storage device (e.g., memory 730 or disc storage) storing (804) a list of license plate numbers and, for each license plate number corresponding information, said license plate numbers including a first license plate number, information corresponding to the first license plate number stored in said storage device including one or more of: i) billing information corresponding to the license plate holder; ii) address information corresponding to the license plate holder, and/or iii) privacy preference information indicating whether the license plate holder of the first license plate seeks to limit the distribution of information corresponding to the first license plate (e.g., whether information associated with the license plate can be provided to other entities and/or the license plate holder does not want anyone who detects the license plate to use it for marketing and/or location tracking purposes); monitoring (805) for messages communicating a license plate number (e.g., in a captured image or in the form of a number which was determined from a captured image and communicated in number form); and

and a processor (724) in a server (708) said processor (724) being configured to determine (808) if the storage device includes information corresponding to a communicated license plate number in response to receipt (806) of a first message communicating the license plate number.

System Embodiment 2. The system of System Embodiment 1, wherein said processor (724) is further configured to determine (810, Y) that the storage device includes information corresponding to the communicated license plate number; and in response to determining that the storage device includes information corresponding to the communicated license plate number, control the server 708 to perform (812) one or more of: i) responding to the message communicating the license plate number with user privacy setting information (e.g., whether or not the license plate number corresponds to a number for which a user has set a privacy restriction such as prohibiting use of license plate number detection information for marketing and/or targeted advertising purposes or location tracking) and/or ii) performing a billing operation for services provided by the sender of the first message without providing the sender billing information (and in some cases without providing license plate holder identification information to the sender of the first message).

System Embodiment 3. The system of System Embodiment 2, wherein the sender of the first message is a parking garage operator.

System Embodiment 4. The system of System Embodiment 3, wherein the sender of the first message is a car service provider (e.g., car wash operator or car repair service provider such as a mechanic).

System Embodiment 5. The system of System Embodiment 1, wherein said processor is configured to control the server to respond to the message communicating the license plate number with user privacy setting information is and wherein the processor controls the server, as part of responding to send a response message to the sender of the first message that they should not use information associated with the license plate number communicated in said first message (e.g., for marketing or license plate holder tracking).

While in various embodiments the components mounted on the vehicle are shown as being distributed at various locations on a vehicle, in some embodiments they are integrated into a license plate frame or other device which can be easily mounted on a vehicle. In such cases the processor used to control the controllable filter(s), GPS receiver used to determine vehicle location, the wireless receiver used to receive control information and a power supply, e.g., lithium battery used in some cases to power the filter(s), processor and wireless receiver are all integrated into a single device, e.g., license plate mount and need not be tied to the vehicle systems.

Numerous variations on the above described methods and apparatus are possible and will be apparent to those skilled in the art in view of the above description of the invention. Such variations are to be considered within the scope of the invention. The methods and apparatus of the present invention may be, and in various embodiments are, implemented using a variety of wireless communications technologies such as CDMA, orthogonal frequency division multiplexing (OFDM), WiFi, and/or various other types of communications techniques which may be used to provide wireless communications links

Some aspects and/or features are directed a non-transitory computer readable medium embodying a set of software instructions, e.g., computer executable instructions, for controlling a computer or other device, e.g., a controller or vehicle to be operated in accordance with the above discussed methods.

The techniques of various embodiments may be implemented using software, hardware and/or a combination of software and hardware. Various embodiments are directed to a control apparatus, e.g., controller which can be implemented using a microprocessor including a CPU, memory and one or more stored instructions for controlling a device or apparatus to implement one or more of the above described steps. Various embodiments are also directed to methods, e.g., a method of performing one or more of the other operations described in the present application. Various embodiments are also directed to a non-transitory machine, e.g., computer, readable medium, e.g., ROM, RAM, CDs, hard discs, etc., which include machine readable instructions for controlling a machine to implement one or more steps of a method.

As discussed above various features of the present invention are implemented using modules. Such modules may, and in some embodiments are, implemented as software modules. In other embodiments the modules are implemented in hardware. In still other embodiments the modules are implemented using a combination of software and hardware. In some embodiments the modules are implemented as individual circuits with each module being implemented as a circuit for performing the function to which the module corresponds. A wide variety of embodiments are contemplated including some embodiments where different modules are implemented differently, e.g., some in hardware, some in software, and some using a combination of hardware and software. It should also be noted that routines and/or subroutines, or some of the steps performed by such routines, may be implemented in dedicated hardware as opposed to software executed on a general purpose processor. Such embodiments remain within the scope of the present invention. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods. Accordingly, among other things, the present invention is directed to a machine-readable medium including machine executable instructions for causing a machine, e.g., processor and associated hardware, to perform one or more of the steps of the above-described method(s).

The techniques of the present invention may be implemented using software, hardware and/or a combination of software and hardware. The present invention is directed to apparatus, e.g., a mobile vehicle which implements one or more of the steps of the present invention. The present invention is also directed to machine readable medium, e.g., ROM, RAM, CDs, hard discs, etc., which include machine readable instructions for controlling a machine to implement one or more steps in accordance with the present invention.

Numerous additional variations on the methods and apparatus of the various embodiments described above will be apparent to those skilled in the art in view of the above description. Such variations are to be considered within the scope.

What is claimed:

1. A privacy protection method, the method comprising:
operating a first filter placed over a first surface displaying information to operate during a first period of time in transparent filter mode of operation; and
operating the first filter to operate during a second period of time in opaque filter mode of operation.

2. The method of claim 1, wherein said first surface displaying information is a surface of: i) a vehicle license plate, ii) a vehicle identification number (VIN) plate, iii) the vehicle, trailer or cargo container, iv) an inspection sticker, v) a registration card or sticker, vi) a parking sticker, parking tag or parking card, vii) a security access sticker, viii) an event access sticker, ix) a VIP access sticker, x) a facility or park access sticker, xi) a usage meter, xii) a permit, xiii) a building or construction related information, or xiv) a display device such as an LCD screen.

3. The method of claim 2, wherein said filter is an LCD filter which is transparent or semi-transparent during said transparent mode of operation allowing numbers on the first surface to be viewed through said filter during the first mode of operation and opaque during the second mode of operation.

4. The method of claim 2, wherein said surface is a surface of a vehicle license plate, said surface includes a vehicle license plate number, the method further comprising:
receiving one or more signals providing: i) user input, ii) control information, iii) vehicle mode of operation information or iv) vehicle location information; and
determining, based on the received one or more signals, whether the first filter is to operate in the transparent filter mode of operation or the opaque filter mode of operation, the mode of operation in which the first filter is to operate being a determined mode of filter operation.

5. The method of claim 4, further comprising:
determining if a current mode of first filter operation is different from the determined filter mode of operation; and
in response to determining that the current mode of filter operation is different from the determined filter mode of operation controlling the first filter to change from the current mode of operation to the determined filter mode of operation.

6. The method of claim 4, wherein receiving one or more signals includes receiving said control information, said control information being communicated in a wireless signal.

7. The method of claim 4, wherein receiving one or more signals includes receiving vehicle mode of operation information indicating one or more of: i) the vehicle is moving or ii) the vehicle is parked.

8. The method of claim 7, further comprising:
operating a processor on said vehicle to control the mode of filter operation based on the received vehicle mode of operation information.

9. The method of claim 7,
wherein receiving one or more signals indicates that the vehicle is parked and
wherein the method further includes:
operating a processor on said vehicle to control the mode of filter operation based on whether or not the vehicle is parked.

10. The method of claim 1, wherein said first surface displaying information is a surface of a physical apparatus mounted on a building.

11. The method of claim 1, further comprising:
operating a second filter placed over a second surface displaying information to operate during a third period of time in transparent filter mode of operation; and
operating the second filter to operate during a fourth period of time in opaque filter mode of operation.

12. The method of claim 11, further comprising:
operating a third filter positioned in a first window viewing area to operate during a fifth period of time in transparent filter mode of operation; and
operating the third filter positioned in the first window viewing area to operate during a sixth period of time in opaque filter mode of operation.

13. The method of claim 11, further comprising:
operating a second filter positioned in a first window viewing area to operate during a third period of time in transparent filter mode of operation; and
operating the second filter positioned in the first window viewing area to operate during a fourth period of time in opaque filter mode of operation.

14. A privacy protection system comprising:
a first filter positioned over a first surface displaying information (e.g., a license plate number); and
a processor configured to control the first filter to: i) operate during a first period of time in transparent filter mode of operation; and ii) operate during a second period of time in opaque filter mode of operation.

15. The system of claim 14, wherein said first surface displaying information is a surface of: i) a vehicle license plate; ii) a vehicle identification number (VIN) plate; iii) the vehicle, trailer or cargo container, iv) an inspection sticker, v) a registration card or sticker, vi) a parking sticker, parking tag or parking card, vii) a security access sticker, viii) an event access sticker, ix) a VIP access sticker, x) a facility or park access sticker, xi) a usage meter, xii) a permit, xiii) a building or construction related information, or xiv) a display device such as an LCD screen.

16. The system of claim 15, wherein said filter is an LCD filter which is transparent or semi-transparent during said transparent mode of operation allowing numbers on the first surface to be viewed through said filter during the first mode of operation and opaque during the second mode of operation.

17. The system of claim 15, wherein said surface is a surface of a vehicle license plate, said surface includes a vehicle license plate number, the system further comprising:
a receiver for receiving one or more signals providing: i) user input, ii) control information, iii) vehicle mode of operation information or iv) vehicle location information; and
wherein the processor is further configured to determine, based on the received one or more signals, whether the first filter is to operate in the transparent filter mode of operation or the opaque filter mode of operation, the mode of operation in which the first filter is to operate being a determined mode of filter operation.

18. The system of claim 17, wherein the processor is further configured to:
determine if a current mode of first filter operation is different from the determined filter mode of operation; and
control, in response to determining that the current mode of filter operation is different from the determined filter mode of operation, the first filter to change from the current mode of operation to the determined filter mode of operation.

19. A method for storing and using information associated with a vehicle license plate number, the method comprising:
storing in a storage device a list of license plate numbers and, for each license plate number corresponding information, said license plate numbers including a first license plate number, information corresponding to the first license plate number stored in said storage device including one or more of: i) billing information corresponding to the license plate holder; ii) address information corresponding to the license plate holder, or iii) privacy preference information indicating whether the license plate holder of the first license plate seeks to limit the distribution of information corresponding to the first license plate;
monitoring for messages communicating a license plate number; and
in response to receiving a first message communicating a license plate number, determining if the storage device includes information corresponding to the communicated license plate number.

20. The method of claim 19, further comprising:
in response to determining that the storage device includes information corresponding to the communicated license plate number performing one or more of: i) responding to the message communicating the license plate number with user privacy setting information or ii) performing a billing operation for services provided by the sender of the first message without providing the sender billing information.

21. The method of claim 20, wherein the sender of the first message is a parking garage operator.

22. The method of claim 20, wherein the sender of the first message is a car service provider.

23. The method of claim 19, wherein responding to the message communicating the license plate number with user privacy setting information is performed and includes sending a response message to the sender of the first message indicating that sender should not use information associated with the license plate number communicated in said first message.
